(19) United States
(12) Patent Application Publication
(10) Pub. No.: US 2025/0103723 A1
(43) Pub. Date: Mar. 27, 2025

(54) METHOD AND STORAGE MEDIUM FOR ASSESSING PRIVACY COMPLIANCE OF ONLINE PLATFORMS

(71) Applicant: Kaamel Technology Inc., Mountain View, CA (US)

(72) Inventors: Zheng BU, Mountain View, CA (US); Yichong LIN, Mountain View, CA (US)

(21) Appl. No.: 18/471,609

(22) Filed: Sep. 21, 2023

(51) Int. Cl. G06F 21/57; G06F 21/62; G06F 40/295

(52) U.S. Cl. CPC G06F 21/577; G06F 21/6245; G06F 40/295

(57) ABSTRACT

The present invention discloses a computer implemented method and non-transitory computer-readable medium for assessing privacy compliance of online platforms. The method is executed by the processor to analyze the privacy policy text on an online platform, monitor the data traffic of the online platform, determine whether the online platform complies with privacy standards in collecting, transmitting, or managing privacy data, and provide a compliance result based on the determination. The compliance result at least includes whether the online platform collects unauthorized personal information from users, and whether it discloses contact information that satisfies the requirement of one or more privacy standards. This automated method significantly reduces the need for manual labor and resource allocation, as it can be implemented on a single computer.

### TECHNICAL FIELD

The present invention generally relates to the field of information technology. The invention relates more specifically to approaches for assessing whether an organization's online platform complies with privacy regulations.

### BACKGROUND OF THE INVENTION

Many modern companies collect copious amounts of data including personal data as part of everyday operations and rely on analytics of this information to run the business. In order to regulate the collection of personal information by organizations, various privacy laws and regulations are enacted worldwide to protect consumers from data misuse. Typically, organizations are required to comply with these regulations by providing clear privacy policies on their online platforms to inform users about the collection of personal data before they provide or agree to provide their privacy data to the online platforms. Organizations, for example, may not collect personal data that is not declared in the provided privacy policy. Personal data includes various types of personally identifiable information (PII), such as names, addresses, dates of birth, social security numbers, and other identifying codes, telephone numbers, email addresses, and more. In addition, certain privacy laws mandate organizations to make their contact information publicly available in the privacy policy.

Failing to comply with privacy laws and regulations can have severe consequences for organizations. Not only does such a breach expose individual users to potential malicious activities, but it also results in reputational damage, potential legal liability, and expensive remedial measures for the organization obligated to safeguard the information. These breaches result in financial losses and undermine the trust and confidence of individuals, stakeholders, and the public.

Consequently, it is important for organizations to make sure that they fully comply with privacy regulations. However, a comprehensive assessment of an organization's compliance of privacy regulations often involves a large amount of data and requires a team of experts with diverse expertise in privacy and local regulations. Moreover, the extensive volume of personal data being exchanged on the online platform makes the assessment frustratingly complex and difficult to navigate.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. In general, the present disclosure provides a computer-implemented method and a computer readable storage medium for assessing privacy compliance of an online platform that address the limitations in the conventional method noted above.

In one aspect, a computer-implemented method assessing compliance of privacy policy text of an online platform is disclosed. The method generally performs the following operations: receiving, by one or more processors of a privacy compliance assessing system, content of the online platform including at least a privacy policy text associated with an online platform; locating, by a locator module executed by the one or more processors, one or more relevant paragraphs within the privacy policy text that relate to disclosure or collection of personal information; extracting, by an extractor module executed by the one or more processors, one or more types of personal information that is disclosed in the relevant paragraphs or will be collected by the online platform according to the relevant paragraphs; monitoring, by a data traffic monitor executed by the one or more processors, data traffic of the online platform during an actual operation of the online platform; making, by a determination module, a determination of compliance of the privacy policy text; and transmitting, by a report module based on the determination, compliance results.

In another aspect, a non-transitory computer-readable medium may store instructions and a processor may execute the instructions to perform one or more operations of any method disclosed herein.

Other technical features may be readily apparent to one skilled in the art from the following figures, descriptions, and claims. To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of a few of the various ways in which the principles of various aspects may be employed, and this description is intended to include all such aspects and their equivalents.

### BRIEF DESCRIPTION OF DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an exemplary network environment in which the method for assessing privacy compliance of an online platform may operate;

FIG. 2 is a block diagram of various modules within an assessment module;

FIG. 3 is a flow chart illustrating an exemplary method for assessing privacy compliance of collection of personal information on an online platform;

FIG. 4 is a flow chart illustrating an exemplary method for assessing privacy compliance of disclosure of contact information on an online platform.

### DETAILED DESCRIPTION

Various aspects are now described with reference to the drawings. In the following description, for the purpose of explanation, numerous specific details are set forth in order to provide a thorough understanding of one or more aspects. It may be evident, however, that such aspect(s) may be practiced without these specific details.

Present invention provides operations for assessing privacy compliance of an organization's online platform in an efficient manner that minimizes human interventions. The online platform may refer to a website or an application that collects data from users and interact with the users in response to the users' prompts. The operations can be performed on a computing device, causing the device to locate privacy policy text of an online platform and paragraphs within the privacy policy text that may give rise to privacy compliance problems, specifically, paragraphs that relate to collection of users' personal information and disclosure of the organization's contact information. The computing device may then analyze which personal information is declared to be collected by the online platform, and which types of contact information is disclosed by the online platform. In one example, data traffic of the online platform is monitored for determining whether the online platform operates is consistent with its own privacy policy. In another example, the computing device may determine whether the contact information disclosed comply with the privacy standard governing the organization. The computing device may show the assessment results to individuals who oversee privacy compliance of the organization's online platform, allowing them to be aware of potential noncompliance, and make timely adjustments to the online platform to ensure compliance with privacy regulations. The individuals may be internal managers of the online platform or may be personels from a third party assessing the privacy compliance of the online platform. The individuals may be referred to as compliance managers.

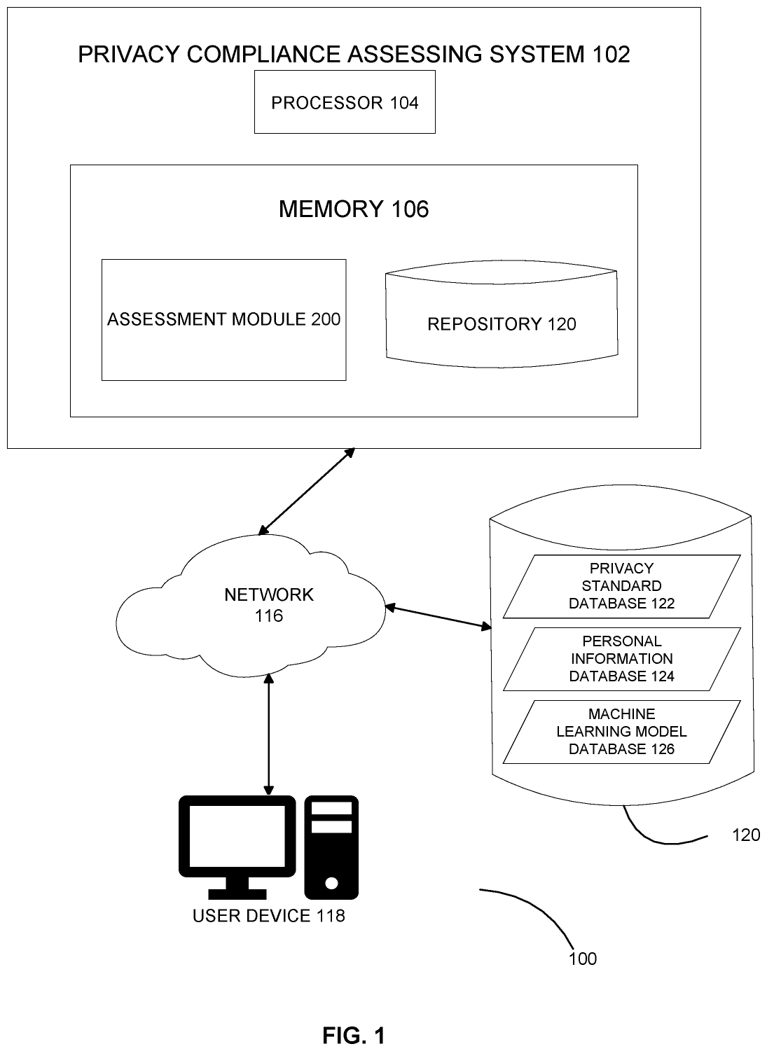

FIG. 1 is a diagram illustrating an exemplary network environment 100 in which the method for assessing privacy compliance of an online platform may operate.

As shown therein, a user device 118 may be in communication with a privacy compliance assessing system 102 over a network 116. User device 118 may be a desktop computer, laptop computer, cell or smartphone, tablet device, or other type of computing device capable of executing a set of instructions (sequential or otherwise) that specify actions to be taken by that device. A compliance manager at user device 118 may manually run an online platform that is intended to be assessed. Electronic documents associated with the online platform may then be communicated to the privacy compliance assessing system 102 over network 116. A compliance manager may also input work requests to assess an online platform at the user device 118. The online platform that can be assessed may include an application or a website. An application may be a mobile application or any other application that is executable by the user device 118.

Network 116 may be a public network (e.g., connected to the Internet via wired (Ethernet) or wireless (Wi-Fi)), a private network (e.g., a local area network (LAN) or wide area network (WAN)), or a combination thereof. Network 116 may also comprise a node or nodes on the Internet of Things (IoT).

A repository 120 may store one or more databases containing data that may be used in various operations of present invention. The repository 120 may communicate with privacy compliance assessing system 102 via network 116 or may be a part of privacy compliance assessing system 102. The privacy compliance assessing system 102 may retrieve data from the repository 120 and store in the memory 106. The repository 120 may include a privacy standard database 122 containing templates of various types of personal information. Personal information may include social security number, date of birth, credit card number, physical address, mailing address, email address, IP address, and so forth. The repository 120 may also include a privacy standard database 122 containing various privacy laws and regulations mandated by one or more governments worldwide, for example, General Data Protection Regulation (GDPR), General Personal Data Protection Law (LGPD), California Consumer Privacy Act (CCPA), Children's Online Privacy Protection Rule (COPPA), Health Insurance Portability and Accountability Act (HIPAA), and the like. The privacy standard database 122 may also include an organization-specific standard particularly adapted or configured for certain organizations. The repository 120 may also include a machine learning database 126 that contains various pre-trained machine learning models which may include Generative Pre-trained Transformer (GPT) model, Named Entity Recognition (NER) model, Bidirectional Encoder Representations from Transformers (BERT) model, and the like.

The privacy compliance assessing system 102 may include a processor 104 and a memory 106. The memory 106 may include any type of storage, which may be physically located on one physical device, or on multiple physical devices. The processor 106 may execute instructions to perform various operations of present invention, for example, instructions to create a virtual environment in which the online platform may be executed.

The privacy compliance assessing system 102 may include an assessment module 200. The assessment module 200 may be loaded within the memory 106 of the privacy compliance assessing system 102 during execution by the processor 106. The assessment module 200 may include one or more modules or units to perform the various operations of present invention described below.

While components in the network environment 100 are shown either as part of the privacy compliance assessing system 102 or as separate independent components communicating with the privacy compliance assessing system 102, it will be appreciated by those skilled in the art that some or all portions of such modules, databases, etc. can be relocated or distributed to achieve any desired system goals or functional requirements.

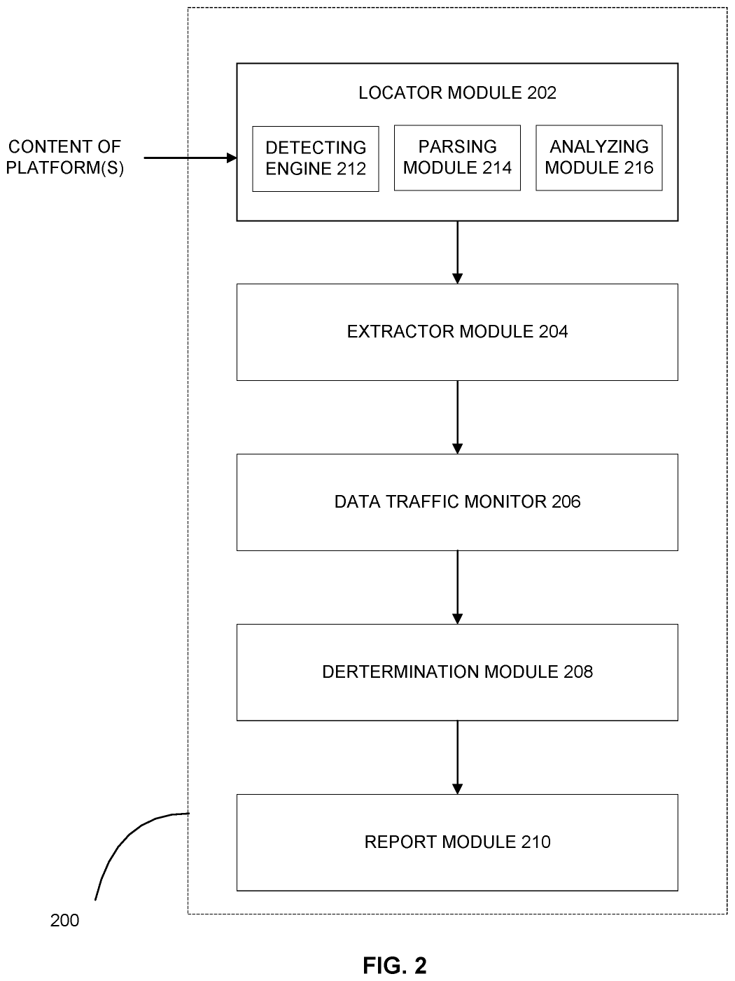

FIG. 2 is a block diagram of various modules and units within the assessment module 200. The assessment module 200 may include a locator module 202, an extractor module 204, a data traffic monitor 206, a determination module 208, and a report module 210. The assessment module 200 may receive an online platform from the user device 118, and may run the online platform in a virtual environment. Content of the online platform may be input to the locator module 202. Content of the online platform includes any text, electronic documents, graphics, images, audio, video, software, data compilations and any other form of information capable of being stored in a computing device that appears on or forms part of the online platform. A module or unit may refer to a software component that interacts with other components in accordance with the disclosure.

The locator module 202 within the assessment module 200 locates privacy policy text within the content of the online platform and further locates paragraphs within the privacy policy text that relate to disclosure or collection of personal information. For example, the locator module 202 may locate paragraphs within the privacy policy text that declare what types of personal information is collected from users of the online platform. The locator module 202 may also locate paragraphs within the privacy policy text that disclose how a user may contact the organization, which may include the name, physical address and email address of the organization. The locator module 202 may include a detecting engine 212, a parsing module 214, and an analyzing module 216.

The detecting engine 212 may be configured to search content of the online platform for portions that relate to privacy policy. The detecting engine 212 may take content of an online platform as input, scan the content, sort elements related to privacy policy in the content according to their relevance to privacy policy, and identify the element with a highest relevance to privacy as the privacy policy text. The relevance to privacy policy may be determined by various factors, such as the Uniform Resource Locator (URL), textual content, and location within the online platform. For example, portions of the content containing the phrase “privacy policy” are considered highly relevant to privacy policy. For example, if a tab is found at the bottom of the online platform, then the page redirected by the tab may be determined to be highly relevant to privacy policy. However, a privacy policy URL found on the website may be determined to be less relevant, as it is more likely to direct to the privacy policy of a third-party Software Development Kit (SDK). For another example, a privacy policy pop-up on an Android application may be determined to be relevant to privacy policy. Pages redirected from application settings of an Android application may also be determined to be relevant to privacy policy.

The obtained privacy policy text may then be provided to the parsing module 214. The parsing module 214 may be configured to parse privacy policy text into separate chapters. Specifically, the parsing module 214 may be configured to identify the titles present within the privacy policy text and determines the paragraphs corresponding to each title. To locate the titles within the privacy policy text, the parsing module 214 may use a BERT fine-tuning model. For example, the parsing module 214 may identify within the privacy policy text a title “How We Use Your Personal Data.” The parsing module 214 may determine paragraphs that correspond to each title based on the relative positions between consecutive titles, thus maintaining a trie structure of titles and corresponding paragraphs.

The parsed privacy policy text may then be provided to an analyzing module 216. The analyzing module 216 may be configured to identify one or more chapters within privacy policy text that relate to disclosure or collection of personal information. The analyzing module 216 may summarize each chapter of the privacy policy text and generate a chapter theme test set comprising information extracted from each chapter that is considered to be the theme of that chapter. The analyzing module 216 may employ a GPT model to generate the chapter theme test set. The analyzing module 216 may locate paragraphs that relate to disclosure or collection of personal information by determining a text similarity between the chapter theme test set and a baseline statement that comprises test segments commonly found in privacy policies specifically addressing the disclosure or collection of personal information. For example, when assessing compliance regarding the collection of personal information, a baseline statement may comprise text “personal information we collect.” When assessing compliance regarding the disclosure of contact information, a baseline statement may comprise text “contact us.” The analyzing module 216 may determine the text similarity by employing a BERT model or a GPT model.

The one or more chapters located by the locator module 202 are provided to an extractor module 204 within the assessment module 200. The extractor module 204 may be configured to extract types of personal information contained within the one or more chapters. For example, if a chapter relates to collection of personal information, the extracted personal information would indicate the specific types of personal information declared to be collected by the online platform. If a chapter relates to disclosure of contact information, the extracted personal information indicates the types of contact information disclosed by the online platform. The extractor module 204 may extract types of personal information by employing a GPT model and a NER model.

The data traffic monitor 112 within the assessment module 200 monitors data traffic of the online platform during an actual operation. An actual operation may include a period during which the online platform engages in at least one instance of data exchange. The data traffic to be monitored may include data submitted by a user, data stored by the online platform, and data transmitted to a third party by the online platform. For different types of online platforms, the data traffic monitor 112 obtains data traffic in different ways. In the case of an application, the data traffic monitor 112 may include an application virtual machine to obtain data traffic through static code analysis, dynamic code analysis, or combination of the two. The data traffic monitor 112 may perform static code analysis to monitor dangerous permissions and system Application Programming Interfaces (APIs) of certain types of personal information used by the application.

Dangerous permissions monitored by the data traffic monitor 112 may include android.permission.CALL_PHONE, android.permission.CAMERA, android.permission.WRITE_EXTERNAL_STORAGE, android.permission.RECORD_AUDIO. Application Programming Interfaces (APIs) monitored by the data traffic monitor 112 may include ‘getdeviceID.’ The data traffic monitor 112 may perform dynamic code analysis to monitor running traffic of the application and obtain types of personal information being transmitted in the running traffic. In a case of a website, the data traffic monitor 112 may read data traffic from HTTP Archive (HAR) format files. The data traffic monitor 112 may read the HAR files by executing traversal algorithms, such as the breadth-first search algorithm, and filter out all requests to static files during the traverse. In order to optimize the operation time, the traversal depth and the total traversed page limit may be predetermined. For websites that need user login and registration, the data traffic monitor 112 may additionally acquire the website's login state. For example, the data traffic monitor 112 may cause the processor 104 to visit the URL of the website and execute a first set of pre-configured operations that are configured to register for the website. The data traffic monitor 112 may cause the processor 104 to execute a second set of pre-configured operations that are configured to login the website. The login status may be stored and reused for subsequent actions. After accessing the HAR files of the website, the data traffic monitor 112 may traverse all HTTP requests and responses in the HAR file and obtain server location information using an IP library. The data traffic monitor 112 may then write the requests and responses to a comma-separated values (CSV) file. Algorithms that may be used in writing to the CSV file may include a “entries_to_csv” function. The data traffic monitor 112 may then use a pre-trained classification model to analyze the entries of the CSV file to decide the presence of PII information within the HAR file. For request or responses containing PII information, the data traffic monitor 112 may use a PII SDK to perform data discovery, identification, classification, and extract PII information.

The determination module 208 within the assessment module 200 may be configured to decide privacy compliance of the online platform based on the privacy policy text and the data traffic of the online platform. The determination module 208 may determine whether the online platform declares in its privacy policy which personal information will be collected from users, and further determines whether the data traffic of the online platform contains personal information that is not included in the types of personal information declared to be collected. For example, if the privacy policy text indicates storage of user information only within the United States, while the data traffic contains personal information transmitted to Europe, then the determination module 208 may determine that the privacy compliance of the online platform is problematic. For another example, if the only personal information declared to be collected in the privacy policy text is Device ID, while the data traffic indicates that personal information other than Device ID is collected from users, then the determination module 208 may determine that the privacy compliance of the online platform is problematic. The determination module 208 may also determine whether the disclosed types of contact information in the privacy policy text meets the privacy standards mandated by one or more governments. Moreover, the determination module 208 may determine whether the contact information disclosed in the privacy policy text adhere to good practices of privacy compliance. For example, if the disclosed physical address is in a country/area that is different from the organization's operational base, the determination module 208 may determines that the online platform does not adhere to good practices of privacy compliance.

The report module 210 within the assessment module 200 may be configured to receive the determinations made by the determination module 208 and transmit compliance results to the user device 118. The report module 210 may enable individuals from the organization who oversee privacy compliance of the online platform to access the compliance results on the user device 118. If the determination module 208 determines that the data traffic of the online platform contains unauthorized personal information that is monitored in the data traffic but is not included in the types of personal information declared to be collected, the report module 210 may transmit a first signal. The first signal may include the specific unauthorized types of personal information that is detected in the data traffic. If the determination module 208 determines that the types of personal information disclosed in privacy policy text does not satisfy certain privacy standards, the report module 210 may transmit a second signal. The second signal may include the missing types of personal information that are required by privacy standards but were not disclosed in the online platform's privacy policy text.

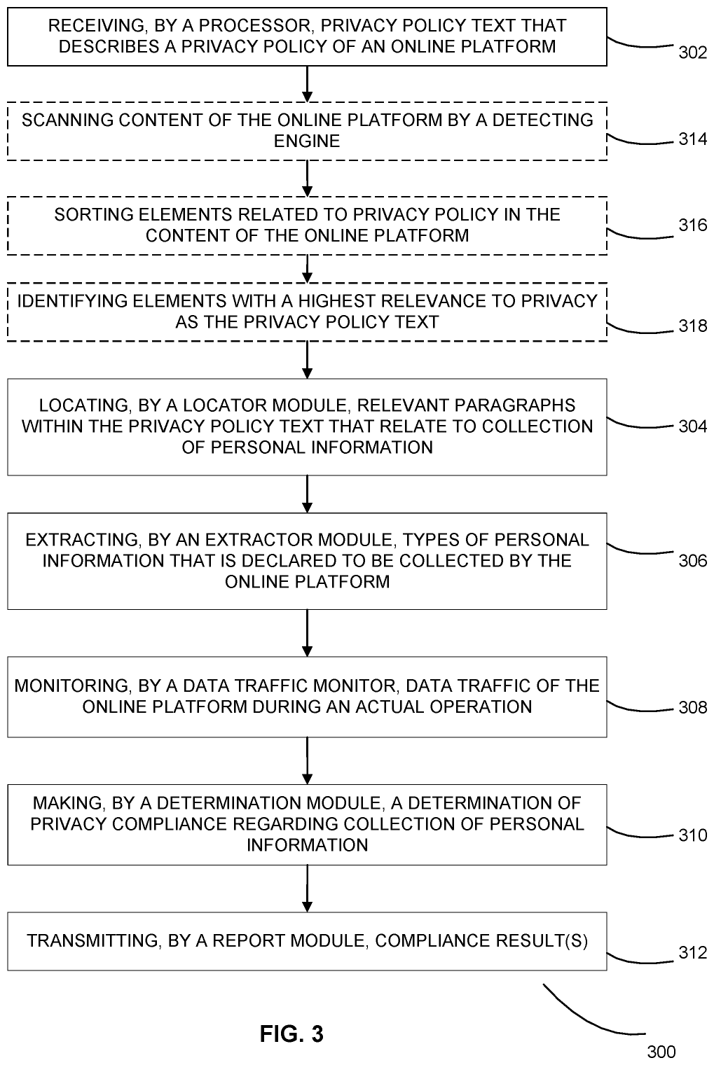

FIG. 3 is a flow chart illustrating an exemplary method 300 for assessing privacy compliance of collection of personal information on an online platform.

At block 302, processor 104 of the privacy compliance assessing system 102 may receive privacy policy text of an online platform that runs in a virtual environment on a user device 118.

Subsequent to block 302, at block 314 a detecting engine within a locator module 202 may scan content of the online platform.

At block 316, locator module 202 may sort elements related to privacy policy in the content of the online platform.

At block 318, locator module 202 may identify elements with a highest relevance to privacy as the privacy policy of text of the online platform. Operations at blocks 314, 316, and 318 may be optional, and may be skipped, and the privacy policy of text of the online platform may be located using other methods.

At block 304, locator module 202 may locate paragraphs within the privacy policy text that declare what types of personal information is collected by the online platform. For example, a paragraph that declares what types of personal information is collected by the online platform may include text “how to use your personal data,” or “personal information we collect,” and the like.

At block 306, extractor module 204 may receive the located paragraphs and extract types of personal information that is declared to be collected by the online platform from the located paragraphs.

At block 308, data traffic monitor 206 may monitor data traffic of the online platform during an actual operation.

At block 310, determination module 208 may make a determination of compliance of the collection of personal information. The determination may be based on whether the data traffic monitored in block 308 is consistent with the privacy policy text disclosed on the online platform itself. Specifically, the determination module 208 determines whether the types of personal information monitored in the data traffic in block 308 is included in the types of personal information extracted in block 306, which are declared to be collected in the privacy policy text.

At block 312, report module 210 may transmit compliance results to the user device 118. In a case where the monitored data traffic contains the collection of types of personal information that are not included in the types of personal information declared to be collected in the privacy policy text, the compliance result comprises a signal of non-compliance. In a case where the collection of the types of personal information in the monitored data traffic are all included in the types of personal information declared to be collected in the privacy policy text cases, the compliance result comprises a signal of compliance. The compliance result may also comprise the specific type of personal information that breaches the compliance and the corresponding data traffic monitored in block 312.

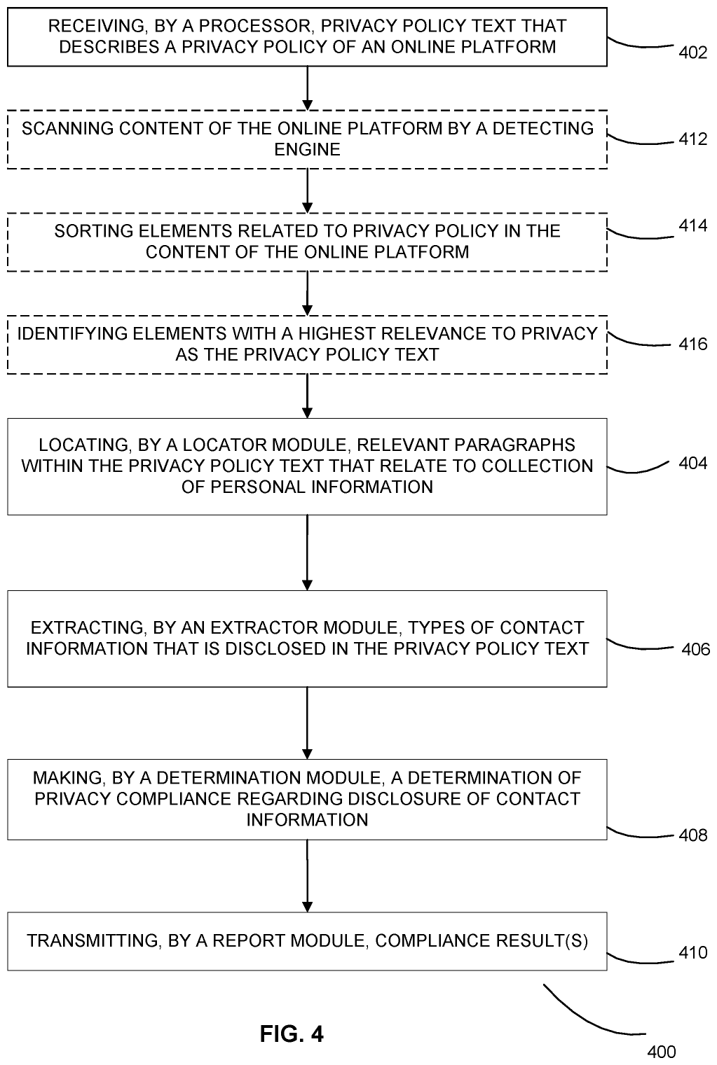

FIG. 4 is a flow chart illustrating an exemplary method 400 for assessing privacy compliance of disclosure of contact information on an online platform.

At block 402, processor 104 of the privacy compliance assessing system 102 may receive content of an online platform that runs in a virtual environment on a user device 118.

Subsequent to block 402, at block 412 a detecting engine within a locator module 202 may scan content of the online platform.

At block 414, locator module 202 may sort elements related to privacy policy in the content of the online platform.

At block 416, locator module 202 may identify elements with a highest relevance to privacy as the privacy policy of text of the online platform. Operations at blocks 412, 414, and 416 may be optional, and may be skipped, and the privacy policy of text of the online platform may be located using other methods.

At block 404, locator module 202 of the privacy compliance assessing system 102 may locate paragraphs within the privacy policy text that relate to disclosure of contact information. For example, a relevant paragraph that relates to disclosure of contact information may include text “Contact Us.” The locator module 106 in block 404 may operate in the same or a similar manner as described above in regard to block 304.

At block 406, extractor module 204 may extract types of personal information that is disclosed in the privacy policy text. The block 406 may be performed in the same or a similar manner as described above in regard to block 306.

At block 408, determination module 208 may make a determination of privacy compliance of the disclosure of contact information. The determination may include determining whether the disclosure of contact information in the privacy policy text complies with one or more privacy standards. The determination may include determining whether the contact information disclosed in the privacy policy text adhere to good practices of privacy compliance.

At block 410, report module 210 may transmit compliance results to the user device 118. In a case where the privacy policy text does not disclose contact information as required by the privacy standards governing the organization, the compliance result comprises a signal of non-compliance. In a case where the privacy policy text discloses contact information as required by the privacy standards governing the organization, the compliance result comprises a signal of compliance. The compliance result may also comprise the specific policy standards that are breached, and the missing type of personal information involved in such a breach.

While this invention has been described with reference to exemplary embodiments, it will be understood by those skilled in the art that various changes can be made, and equivalents may be substituted without departing from the spirit and scope of the invention. A number of other conventional operations that would be included in implementing the method on a computer have been omitted, as well, to better emphasize the present teachings. In addition, modifications may be made to adapt the teachings of the invention to particular situations and materials without departing from the essential scope thereof. Thus, the invention is not limited to the particular examples that are disclosed herein but encompasses all embodiments falling within the scope of the appended claims.

Implementations of the various techniques described herein may be implemented as a computer program embodied in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. Such implementations may be referred to herein as implemented via a non-transitory “computer-readable storage medium.”

It will also be apparent to those skilled in the art that the modules of the present disclosure, including those illustrated in the figures can be implemented using any one of many known programming languages suitable for creating applications that can run on large scale computing systems, including servers connected to a network as part of a cloud computing system. The details of the specific implementation of the present disclosure will vary depending on the programming language(s) used to embody the above principles, and are not material to an understanding of the present disclosure.

What is claimed is:

1. A computer implemented method for assessing privacy compliance of an online platform, comprising:
receiving, by one or more processors of a computing system, privacy policy text that describes a privacy policy of an online platform;
locating, by a locator module executed by the one or more processors, one or more relevant paragraphs within the privacy policy text that relate to disclosure or collection of personal information, wherein the locator module locates the relevant paragraphs at least in part by determining a text similarity between the relevant paragraphs and a baseline statement, wherein the baseline statement comprises texts of common privacy policies specifically addressing the disclosure or collection of personal information;
extracting, by an extractor module executed by the one or more processors, one or more types of personal information that is disclosed in the relevant paragraphs or will be collected by the online platform according to the relevant paragraphs;
monitoring, by a data traffic monitor executed by the one or more processors, data traffic of the online platform during an actual operation of the online platform, wherein the data traffic monitor monitors data traffic at least in part by static code analysis, dynamic code analysis, and reading from a HTTP Archive (HAR) format files of the online platform;
making, by an determination module executed by the one or more processors, a determination of compliance of the privacy policy text based on at least one of:
determining whether the data traffic contains personal information not included in the one or more types of personal information declared to be collected; and
determining whether the one or more types of personal information that is disclosed in the relevant paragraphs fulfills one or more privacy standards mandated by one or more governments; and
transmitting, by the one or more processors, based on the determination, compliance results.

2. The method of claim 1, further comprising:
scanning content of the online platform by a detecting engine executed by the one or more processors,
sorting elements related to privacy policy in the content of the online platform according to the relevance to privacy of each of the elements, and
identifying the element with a highest relevance to privacy as the privacy policy text, wherein the detecting engine determines the relevance based on information including link Uniform Resource Locator (URL), text, and location of the pages.

3. The method of claim 1, further comprising:
locating titles of the privacy policy text using a Bidirectional Encoder Representations from Transformers (BERT) fine-tuning model executed by the one or more processors; and
locating paragraphs corresponding to the titles based on relative position before the titles.

4. The method of claim 1, wherein the locator module comprises a Generative Pre-trained Transformers (GPT) model and a BERT model.

5. The method of claim 1, wherein the extractor module comprises a GPT model and a Named Entity Recognition (NER) model.

6. The method of claim 1, wherein the compliance results comprise a first signal in response to determining that the data traffic contains personal information not included in the one or more types of personal information declared to be collected, the first signal includes one or more unauthorized type of personal information, the one or more unauthorized type of personal information is monitored in the data traffic but is not included in the one or more types of personal information declared to be collected.

7. The method of claim 1, wherein the compliance results comprise a second signal in response to determining that the one or more types of personal information disclosed in the relevant paragraphs does not fulfill the one or more privacy standards mandated by the one or more government, the second signal includes one or more missing types of personal information, the one or more missing types of personal information is required by the one or more privacy standards mandated by the one or more government but is not disclosed in relevant paragraphs.

8. The method of claim 1, wherein the online platform comprises an application and a website.

9. A non-transitory computer-readable medium having stored thereon instructions executable by one or more processors to cause a computing system to perform operations:
receiving, by one or more processors of a computing system, privacy policy text associated with an online platform;
locating, by a locator module executed by the one or more processors, one or more relevant paragraphs within the privacy policy text that relate to disclosure or collection of personal information, wherein the locator module locates the relevant paragraphs at least in part by determining a text similarity between the relevant paragraphs and a baseline statement, wherein the baseline statement comprises texts of common privacy policies specifically addressing the disclosure or collection of personal information;
extracting, by an extractor module executed by the one or more processors, one or more types of personal information that is disclosed in the relevant paragraphs or will be collected by the online platform according to the relevant paragraphs;
monitoring, by a data traffic monitor executed by the one or more processors, data traffic of the online platform during an actual operation of the online platform, wherein the data traffic monitor monitors data traffic at least in part by static code analysis, dynamic code analysis, and reading from a HTTP Archive (HAR) format files of the online platform;
making, by an determination module executed by the one or more processors, a determination of compliance of the privacy policy text based on at least one of:
determining whether the data traffic contains personal information not included in the one or more types of personal information declared to be collected; and
determining whether the one or more types of personal information that is disclosed in the relevant paragraphs fulfills one or more privacy standards mandated by one or more governments; and
transmitting, by the one or more processors, based on the determination, compliance results.

10. The non-transitory computer-readable medium of claim 9, further comprising:
scanning content of the online platform by a detecting engine executed by the one or more processors,
sorting elements related to privacy policy in the content of the online platform according to the relevance to privacy of each of the elements, and
identifying the element with a highest relevance to privacy as the privacy policy text, wherein the detecting engine determines the relevance based on information including link URL, text, and location of the pages.

11. The non-transitory computer-readable medium of claim 9, further comprising:
locating titles of the privacy policy text using a BERT fine-tuning model executed by the one or more processors; and
locating paragraphs corresponding to the titles based on relative position before the titles.

12. The non-transitory computer-readable medium of claim 9, wherein the locator module comprises a GPT model and a BERT model.

13. The non-transitory computer-readable medium of claim 9, wherein the extractor module comprises a GPT model and a NER model.

14. The non-transitory computer-readable medium of claim 9, wherein the compliance results comprise a first signal in response to determining that the data traffic contains personal information not included in the one or more types of personal information declared to be collected, the first signal includes one or more unauthorized type of personal information, the one or more unauthorized type of personal information is monitored in the data traffic but is not included in the one or more types of personal information declared to be collected.

15. The non-transitory computer-readable medium of claim 9, wherein the compliance results comprises a second signal in response to determining that the one or more types of personal information disclosed in the relevant paragraphs does not fulfill the one or more privacy standards mandated by the one or more government, the second signal includes one or more missing types of personal information, the one or more missing types of personal information is required by the one or more privacy standards mandated by the one or more government but is not disclosed in relevant paragraphs.

16. The non-transitory computer-readable medium of claim 9, wherein the online platform comprises an application and a website.
